(19) United States
(12) Patent Application Publication
(10) Pub. No.: US 2008/0007525 A1
(43) Pub. Date: Jan. 10, 2008

(54) Modifiable mouse with a biased switch and a method for modifying a mouse

(75) Inventor: Li Ern Ernest Sim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/483,081

(22) Filed: Jul. 7, 2006

(51) Int. Cl. G09G 5/08

(52) U.S. Cl. 345/163

(57) ABSTRACT

There is provided a mouse for a computer including at least one biased short throw flip-switch located at an opening at a face (either at a top or side face) of the mouse, where the biased short throw flip-switch maintains reach at one consistent position and allows a user of the mouse to manipulate the switch without altering the manner that the mouse is held. In addition, the mouse may include a top cover with a recessed portion to securely receive a supplementary cover, where placement of the supplementary cover in the recessed portion allows the user to alter a manner that the mouse is held. There is provided a method of modifying a mouse including changing a supplementary cover to alter the mass of the mouse and to alter a manner the mouse is held by a user.

### FIELD OF INVENTION

This invention relates to a computer mouse, specifically but not exclusively to a mouse with a biased switch that may be modified by swapping a supplementary cover and a corresponding method to modify the mouse.

### BACKGROUND

A mouse is a ubiquitous computer input device. The capability of the mouse to generate position signals plus one or more binary control signals with just one hand of a user has turned the mouse into an essential tool for interactive computer program control. Common applications may include computer games, presentation and processing software, and Internet browsing.

However, a common gripe about the mice that are used nowadays relates to the lack of options to easily modify mice to a preferred appearance or feel. There are people and organisations that provide services to change the appearance of mice, but such services are not easily affordable and rather inconvenient. The peripheral manufacturers' currently adopt the mindset that expect users to accept the appearance and/or feel of the mice from the day that the mice are purchased, and for users to change their mice once they get jaded about the appearance and/or feel of the mice. Such a practice is wasteful as mice are durable devices that often last longer than the computers that they are connected to.

It is also another gripe of users that mice with buttons to toggle pre-determined functions affect a manner that the mice is held. Pressing buttons on a top or side face of the mice usually loosens the grip of the users holding the mice and correspondingly may also increase strain on the users' wrists when attempting to press the buttons.

### SUMMARY

In a first aspect of the present invention, there is provided a mouse for a computer including at least one biased short throw flip-switch located at an opening at a face (either at a top or side face) of the mouse, where the biased short throw flip-switch maintains reach at one consistent position and allows a user of the mouse to manipulate the switch without altering the manner that the mouse is held. Preferably, the flip-switch may include a contoured lip to aid in toggling of the switch. The flip-switch may preferably be compressible and may be able to be toggled in four directions. It is advantageous that the flip-switch may be coupled to one of at least one LED or a display, wherein one of at least one LED or a display indicates either resolution of the mouse or an activation of a particular function of the mouse.

In addition, the mouse may include a top cover with a recessed portion to securely receive a supplementary cover, where placement of the supplementary cover in the recessed portion allows the user to alter a manner that the mouse is held. The recessed portion of the top cover may preferably be located towards a rear end of the mouse. Alternatively, the recessed portion may extend to a base of the mouse to securely receive the supplementary cover, with the supplementary cover maintaining a low level of friction between the base of the mouse and a surface of use. It is preferable that the supplementary cover is weighted to alter the mass of the mouse. The supplementary cover may also be contoured to conform to a palm of the user. The supplementary cover may be made from materials such as, for example, composites, plastics and metals. It is preferable that the supplementary cover is secured to the recessed portion using a fastener such as, for example, clips, velcro and adhesives.

Generally, the manner the mouse is held depends factors like: secure-ness of grip, extent of strain on a wrist joint of the user and a combination of the aforementioned.

In another aspect of the present invention, there is provided a method of modifying a mouse including changing a supplementary cover to alter the mass of the mouse and to alter a manner the mouse is held by a user. Preferably, the supplementary cover is securely received in a recessed portion on a top cover of the mouse. The recessed portion of the top cover may preferably be located towards a rear end of the mouse. Alternatively, the recessed portion may extend to a base of the mouse to securely receive the supplementary cover, with the supplementary cover maintaining a low level of friction between the base of the mouse and a surface of use. It is preferable that the supplementary cover is secured to the recessed portion using a fastener such as, for example, clips, velcro and adhesives. The supplementary cover may weighted to alter the mass of the mouse and may be contoured to conform to a palm of the user. The supplementary cover may be made from materials such as, for example, composites, plastics and metals.

### DESCRIPTION OF DRAWINGS

In order that the present invention may be fully understood and readily put into practical effect, there shall now be described by way of non-imitative example only preferred embodiments of the present invention, the description being with reference to the accompanying illustrative drawings.

FIG. 1 shows an exploded view of a preferred embodiment of the present invention.

FIG. 2 shows an assembled view of the preferred embodiment of the present invention.

FIG. 3 shows an alternative embodiment of the present invention.

### DESCRIPTION OF PREFERRED EMBODIMENTS

The following discussion is intended to provide a brief, general description of a suitable computing environment in which the present invention may be implemented. As those skilled in the art will appreciate, the invention may be practiced with other computer system configurations, including hand-held devices, multiprocessor systems, microprocessor-based or programmable consumer electronics, minicomputers, and the like.

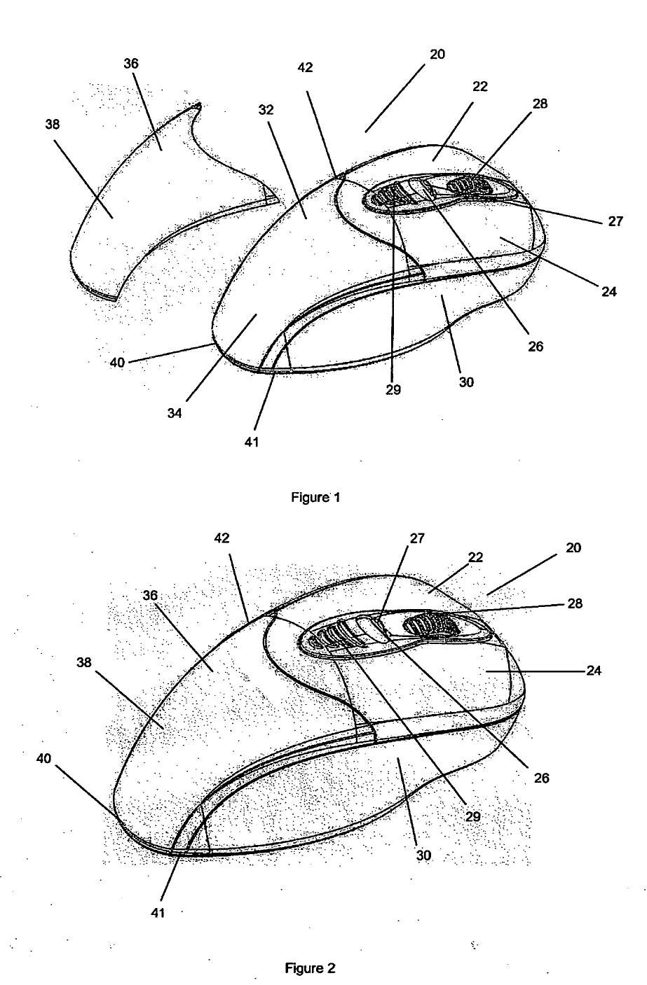

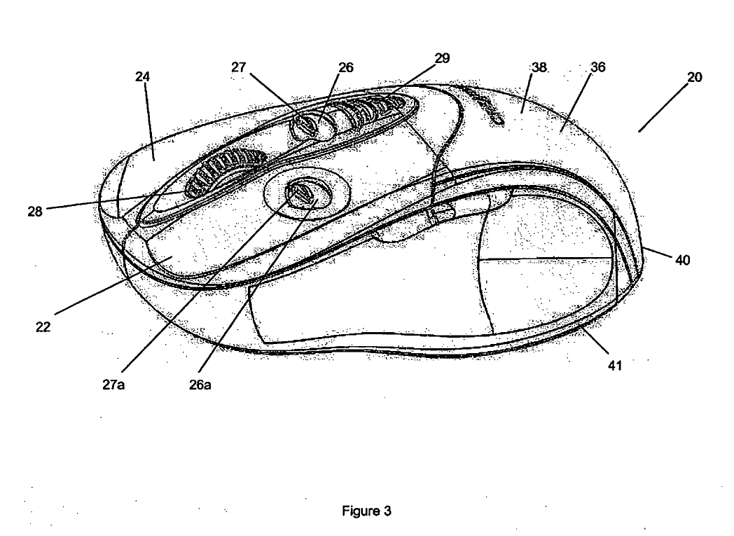

FIGS. 1 and 2 show a mouse 20 for a computer. The mouse 20 may be either wired or wireless. Advantageously, the mouse 20 may be modifiable. The mouse 20 has a first button 22, a second button 24 and a scroll wheel 28 like a conventional mouse. A top cover 32 of the mouse 20 may have a recessed portion 34 to securely receive a supplementary cover 36. The supplementary cover 36 may be secured to the recessed portion of the top cover 32 of the mouse 20 using clips, velcro, adhesives or any suitable form of fastener. In the preferred embodiment of the invention as shown in FIGS. 1 and 2, the recessed portion 34 of the top cover 32 is located towards a rear end 40 of the mouse 20. The recessed portion 34 may extend from the rear end 40 of the mouse 20 to beyond the middle portion of the mouse 20 along the top cover 32. The recessed portion 34 may also extend past the rear end 40 of the mouse 20 onto a base 41 of the mouse 20. In an instance when the recessed portion 34 extends past the rear end 40 of the mouse 20 onto the base 41, the supplementary cover 36 may differ from the appearance as denoted in FIGS. 1 and 2 as the cover 36 may appear more like a sheath which encapsulates the rear end 40 of the mouse 20. A portion of the supplementary cover 36 (which encapsulates the rear end 40 of the mouse 20) that remains in contact with a surface of use may include low friction pads to enable smooth movement of the mouse 20 across the surface of use. As such, the supplementary cover 36 may also be replaced to maintain low friction between the mouse 20 and the surface of use.

The mouse 20 may include at least one biased flip-switch 26 located at an opening in a face of the mouse 20. Biasing of the switch 26 enables the switch 26 to revert to an equilibrium position after the switch 26 is toggled. This allows the switch 26 to be consistently reach-able by a user's finger or thumb, depending on the location of the switch 26. The switch 26 may be of a “short-throw” type, as such a switch type allows for toggling without excessive bending of the user's finger or thumb. The “short-throw” type of switch also eliminates an excessive rebound of the switch 26 after toggling. In addition, the switch 26 may have a contoured lip 27 to aid in toggling the switch 26. The lip 27 aids in toggling of the switch 26. The lip 27 may also aid in toggling the switch 26 without excessive bending of the user's finger or thumb. The lip 27 on the switch 26 as shown in FIGS. 1 and 2 is located on a portion of the switch 26 which creates an appearance that the lip 27 is forward-pointing. This forward-pointing location of the lip 27 may further aid the toggling of the switch 26. The switch 26 may activate/deactivate a particular function by only toggling the switch 26 in only a forward manner. Similarly, the switch 26 may activate/deactivate a particular function by only toggling the switch 26 in only a rearward manner. Alternatively, a forward toggling of the switch 26 activates a particular function and a rearward toggling of the switch 26 de-activates that particular function. Conversely, a forward toggling of the switch 26 may de-activate a particular function while a rearward toggling of the switch 26 may activate that particular function.

In an alternative embodiment, the switch 26 may allow for more than forward and rearward toggling. The switch 26 may be able to sway sideways (to a first side and a second side). Similar to the previous paragraph, the switch 26 may activate/deactivate a particular function by only swaying the switch 26 to a first side. Similarly, the switch 26 may activate/deactivate a particular function by only swaying the switch 26 to a second side. Alternatively, swaying the switch 26 to the first side activates a particular function and swaying the switch 26 to the second side de-activates that particular function. Conversely, swaying the switch 26 to the first side may de-activate a particular function while swaying the switch 26 to the second side may activate that particular function. The switch 26 may also be compressible to enable activation/deactivation of a particular function. It may be possible to reduce the number of components used in the mouse 20 by removing the scroll wheel 28 and correspondingly configuring the switch 26 to take over the functionalities of the scroll wheel 28.

FIGS. 1 and 2 show the switch 26 located at an opening at a top face of the mouse 20. Locating the switch 26 between the first button 22 and second button 24 as shown in FIGS. 1 and 2 allows for manipulation of the switch 26 with the user's index (or middle) finger without compromising secure-ness of grip, and without adding strain to the user's wrist. The function of the switch 26 may be determined by the mouse manufacturer or may be pre determined by the user. The function of the switch 26 may be, for example, to change resolution of the mouse 20, to activate/de-activate a function in a game or program, to activate/de-activate a function of the mouse 20 and so forth. The switch 26 may also be incorporated at an opening at a first side face 30 of the mouse 20 (not shown). Having the switch 26 on the first side face 30 may be preferable for left handed users as the switch 26 may be most easily manipulated using the user's thumb when the switch 26 is located at sides of the mouse 20. It is preferable that the switch 26 is located on a second side 42 of the mouse 20 for right handed users. Locating the switch 26 at the side faces 30, 42 allows for manipulation of the switch 26 with the users thumb without compromising secure-ness of grip, and without adding strain to the user's wrist. The switch 26 may be biased so that a user's index (or middle) finger/thumb (for switch 26 located on the top/side face respectively) only reaches one consistent position to toggle the switch 26 to activate/deactivate a function. This also allows for manipulation of the switch 26 with the user's index (or middle) finger/thumb without compromising secure-ness of grip, and without adding strain to the user's wrist.

Referring to FIG. 3, a second switch 26a may be located at a position along the first button 22. Such a location for the second switch 26a also allows for manipulation of the switch 26a with the user's index finger without compromising secure-ness of grip, and without adding strain to the user's wrist. It is conceivable that similar switches may also be located at a position along the second button 24 or at a position towards the rear 40 of the mouse 20, with the latter employable in instances where the mouse 20 does not have a supplementary cover 36.

The switch 26 may be coupled to at least one LED 29 or a display. The display may be, for example, a TFT panel, an LCD panel, an OLED panel and other similar display panels which may fit within a mouse casing. The at least one LED 29 (or the display) in the mouse 20 may indicate the resolution the mouse 20 is in, an activation of a particular function of the mouse 20, and so forth Toggling the switch 26 may simultaneously activate/deactivate a function and generate an indication with the at least one LED 29 (or the display). Alternatively, toggling the switch 26 may only activate/deactivate a function and an indication with the at least one LED 29 (or the display) is only subsequently generated.

The supplementary cover 36 may be weighted to alter the mass of the mouse 20. The supplementary cover 36 may be made from materials such as, for example, composites (carbon fibre), plastics or metals. The choice of materials used to make the supplementary cover 36 may directly affect the mass of the mouse 20. A top surface 38 of the supplementary cover 36 may painted, stickered or aesthetically enhanced in any manner to enhance the overall appearance of the mouse 20. Pieces of the supplementary cover 36 may be made to commemorate special events/occasions or may be used to decorate the mouse 20 in a particular theme or style. The top surface 38 of the supplementary cover 36 may also be coated with a layer of high coefficient of friction to enhance contact grip between a palm of the user and the mouse 20. Altering the mass of the mouse 20 directly affects how the mouse 20 feels when in use. Some users may prefer to use heavier mice while some users may prefer to use lighter mice. The supplementary cover 36 may be contoured to conform to the palm of the user. Generally, people of different races/sex/size have different-sized hands, thus, the supplementary cover 36 may enable the mouse 20 to comfortably conform to palms of users of all hand sizes. Placing the supplementary cover 36 in the recessed portion 34 also aids in allowing manipulation of the switch 26 (wherever it is located on mouse 20) without compromising secure-ness of grip, and without adding strain to the user's wrist.

There is also provided a method of modifying the mouse 20 that includes changing the supplementary cover 36 to alter the mass of the mouse 20 and to alter a manner the mouse 20 is held by the user as per the mouse 20 described earlier.

Whilst there has been described in the foregoing description preferred embodiments of the present invention, it will be understood by those skilled in the technology concerned that many variations or modifications in details of design or construction may be made without departing from the present invention.

1. A mouse for a computer including:
at least one biased short throw flip-switch located at an opening at a face of the mouse;
wherein the biased short throw flip-switch maintains reach at one consistent position and allows a user of the mouse to manipulate the switch without altering the manner that the mouse is held.

2. The mouse of claim 1, wherein the flip-switch includes a contoured lip to aid in toggling of the switch.

3. The mouse of claim 1, wherein the flip-switch is coupled to one of at least one LED or a display, wherein one of at least one LED or a display indicates either resolution of the mouse or an activation of a particular function of the mouse.

4. The mouse of claim 1, wherein the flip-switch is able to be toggled in four directions.

5. The mouse of claim 1, wherein the flip-switch is compressible.

6. The mouse of claim 1, further including a top cover with a recessed portion to securely receive a supplementary cover, wherein placing the supplementary cover in the recessed portion allows the user to alter a manner that the mouse is held.

7. The mouse of claim 6, wherein the recessed portion of the top cover is located towards a rear end of the mouse.

8. The mouse of claim 6, wherein the supplementary cover is weighted to alter the mass of the mouse.

9. The mouse of claim 6, wherein the supplementary cover is contoured to conform to a palm of the user.

10. The mouse of claim 6, wherein the recessed portion extends to a base of the mouse to securely receive a supplementary cover, with the supplementary cover maintaining low friction between the base of the mouse and a surface of use.

11. The mouse of claim 1, wherein the opening is at a face of the mouse selected from the grasp consisting of: top face and side face.

12. The mouse of claim 6, wherein the supplementary cover is made from materials selected from the group consisting of: composites, plastics and metals.

13. The mouse of claim 6, wherein the supplementary cover is secured to the recessed portion using a fastener selected from the group comprising: clips, velcro and adhesives.

14. The mouse of claim 6, wherein the manner the mouse is held depends to a factor selected from the group comprising: secure-ness of grip, extent of strain on a wrist joint of the user and a combination of the aforementioned.

15. A method of modifying a mouse including changing a supplementary cover to after the mass of the mouse and to alter a manner the mouse is held by a user.

16. The method of claim 15, wherein the supplementary cover is securely received in a recessed portion on a top cover of the mouse.

17. The method of claim 16, wherein the recessed portion of the top cover is located towards a rear end of the mouse.

18. The method of claim 16, wherein the recessed portion extends to a base of the mouse to securely receive a supplementary cover, with the supplementary cover maintaining low friction between the base of the mouse and a surface of use.

19. The method of claim 16, wherein the supplementary cover is secured to the recessed portion using a fastener selected from the group comprising: clips, velcro and adhesives.

20. The method of claim 15, wherein the supplementary cover is weighted to alter the mass of the mouse.

21. The method of claim 15, wherein the supplementary cover is contoured to conform to a palm of the user.

22. The method of claim 15, wherein the supplementary cover is made from materials selected from the group consisting of: composites, plastics and metals.

23. The method of claim 15, wherein the manner the mouse is held depends to a factor selected from the group comprising: secure-ness of grip, extent of strain on a wrist joint of the user and a combination of the aforementioned.
